(19) United States
(12) Patent Application Publication
(10) Pub. No.: US 2006/0201861 A1
(43) Pub. Date: Sep. 14, 2006

(54) Water treatment mixture and system for use

(76) Inventor: Wing Yip Young, Sausalito, CA (US)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/746,451

(22) Filed: Dec. 23, 2003

(51) Int. Cl. B01D 17/09

(52) U.S. Cl. 210/176

(57) ABSTRACT

A product and system for cleaning water or industrial and sewage waste water includes a mixture of diatomite that is heated and stirred to impart a lasting low level negative electrical charge to the diatomite. A mixture of approximately 50% aluminum chloride (AlCl) by volume is blended to provide a powder mixture for use as a flocculant in the system. According to a modification, the charged diatomite is instead blended with a mixture of approximately 50% ferric chloride (FeCl₃) by volume and is stored in liquid form for later use as a flocculant in the system. From one to five percent, by volume, of polyacrylamide is preferably added to the mixture for use in sewage waste water treatment applications. An efficient system for reacting either the mixture or separately adding the diatomite and the metallic chloride to the water is described.

### BACKGROUND OF THE INVENTION

1. Field of the Invention

The present invention, in general relates to water purification and, more particularly, to industrial and sewage waste-water treatment.

The treatment of industrial waste water and sewage has posed many difficult problems to overcome. For example, various chemicals that are present in industrial waste water resist removal. Similarly, sewage waste water may also contain a wide array of substances, some of which are also difficult to separate from the water.

Even when present methods work, there are areas that can be improved. For example, the area of land that is required for such treatment is a valuable commodity as well and it is desirable to reduce the area that is required for the treatment of either industrial waste water or sewage.

It is also desirable to reduce the investment required in water treatment-building construction and also the cost of operation afterwards.

It is similarly desirable to increase efficiency in purifying industrial waste water and sewage water, thereby providing a higher quality of water for release into the environment as well as lessening the need for treatment chemicals and flocculants.

It is also desirable to be able to adapt to changes in flow rates, for example when sewage flow rates increase or decrease while maintaining a high treatment efficiency.

It is further desirable that such operation be temperature insensitive over the normal operating temperature range of the system.

It is desirable that much of the remaining accumulated sludge be of sufficient quality that it can be used as fertilizer, thereby creating a revenue stream.

Also, prior waste water treatment methods and systems tend to be slow, often requiring twelve or more hours to chemically react with certain flocculants or to be affected by biological treatment methods sufficient for discharge. If the time required is great, then a substantially large facility is required to treat a correspondingly large flow rate. If the treatment process is slow, the facility may simply not be able keep up with the flow during peak periods. The risk of then having to, by way of mere necessity, discharge substantially polluted waste water also arises. This poses a bio-hazard for all concerned.

The above needs also apply in general to the purification of water, for whatever purpose and regardless of how the water is to be used, and in particular, water that will subsequently be used as drinking water. Drinking water often begins as river or lake water and is apt to contain a variety of pollutants and organisms that require removal prior to consumption. The instant invention applies to the purification and treatment of drinking water, as well.

Accordingly, there exists today a need for a water treatment mixture and system for use that furthers the attainment of these objectives.

Clearly, such a product and system would be useful and desirable.

2. Description of Prior Art

Waste water treatment mixtures and systems are, in general, known. The use of diatomite to filter beer, stabilize dynamite, or improve asphalt are known. Diatomite has also been used in China to filter sewage with different mixtures and always with an intermediate filter. While the structural arrangements of the known types of products and systems may, at first appearance, have similarities with the present invention, they differ in material respects. These differences, which will be described in more detail hereinafter, are essential for the effective use of the invention and which admit of the advantages that are not available with the prior products and systems.

### OBJECTS AND SUMMARY OF THE INVENTION

It is an object of the present invention to provide a water treatment mixture and system for use that includes a diatomite and a metallic chloride mixture for use as a flocculant.

It is also an important object of the invention to provide a water treatment mixture and system for use that is faster at purifying water than previously known types of chemical or biological treatment.

Another object of the invention is to provide a water treatment mixture and system for use that includes electrically charged diatomite and a metallic chloride mixture for use as a flocculant.

Still another object of the invention is to provide a water treatment mixture and system for use that includes electrically charged diatomite and a metallic chloride mixture as a flocculant which can be prepared ahead of time and then stored for later use for an extended period of time without a significant loss of electrical charge or efficacy.

Still yet another object of the invention is to provide a water treatment mixture and system for use that does not require the use of filters.

Yet another important object of the invention is to provide a water treatment mixture and system for use that is useful in treating either industrial waste water or sewage.

Still yet another important object of the invention is to provide a water treatment mixture and system for use that further advances the goals of reducing the amount of land required by a treatment facility and also the amount of land that is required for the storage of sludge, and which requires a lower initial investment for construction of the treatment facility and which provides for long term economical operation of the treatment facility, and which improves water treatment efficiency, and provides adaptability for responding quickly to changes in the flow rate, and is not affected by reasonable temperature fluctuations, and which helps to reduce subsequent environment contamination.

A first continuing object of the invention is to provide a water treatment mixture and system for use that is effective at extracting germs, bacteria, and organisms from the water.

A second continuing object of the invention is to provide a water treatment mixture and system for use that is effective at attracting, condensing, and settling suspended particles out of city and industrial waster water.

A third continuing object of the invention is to provide a water treatment mixture and system for use that is adapted to permit the waste particles to settle to the bottom of a tank while permitting clear water to accumulate and flow out from the top of the tank.

A fourth continuing object of the invention is to provide a water treatment mixture that can be packaged, stored, and sold for later use as a flocculant.

A fifth continuing object of the invention is to provide a water treatment mixture and system for use that is effective at removing heavy metals as well as inks from industrial waste water and from sewage.

A sixth continuing object of the invention is to provide a water treatment mixture and system for use that is effective at cleansing especially dirty industrial waste water or sewage waste water.

A seventh continuing object of the invention is to provide a water treatment mixture and system for use that is effective at treating industrial waste water or sewage waste water without the need for an intermediate filter (i.e., a screen).

An eighth continuing object of the invention is to provide a water treatment mixture and system for use that utilizes a reaction chamber and one settling tank instead of a plurality of settling ponds.

A ninth continuing object of the invention is to provide a water treatment mixture and system for use that utilizes two or more reaction chambers for each settling tank.

A tenth continuing object of the invention is to provide a water treatment mixture and system for use that can purify incoming waste water sufficient for discharge within approximately two hours of time.

An eleventh continuing object of the invention is to provide a water treatment mixture and system for use that utilizes as many reaction chambers and as many settling tanks as necessary to accommodate the quantity of flow required at any size of water treatment facility.

Briefly, a water treatment mixture and system that is constructed in accordance with the principles of the present invention has a mixture diatomite that is heated to from between 180 to 200 degrees Fahrenheit preferably in an iron container and stirred thereby imparting a lasting low level negative electrical charge to the diatomite. A mixture of approximately 50% aluminum chloride (AlCl) by volume is blended to provide a mixture that is in powder form and which retains its electrical charge for approximately one year for later use as a flocculant in the described system. According to a modification, the charged diatomite is blended with a mixture of approximately 50% ferric chloride (FeCl₃) by volume that soaks up ambient moisture (as a desiccant) or which can have additional water added thereto sufficient so that it is stored in liquid form for later use as a flocculant in the preferred system. For waste water treatment (i.e., sewage) it is preferable to add from 1-5%, by volume, of polyacrylamide to the mixture. An efficient system for reacting the mixture with the waste water is also described.

### BRIEF DESCRIPTION OF THE DRAWINGS

FIG. 1 is a block diagrammatic view of a waste water treatment mixture.

FIG. 2 is a block diagrammatic view of a waste water system utilizing the mixture of FIG. 1.

FIG. 3 is a side view of a reaction chamber of the system of FIG. 2.

FIG. 4 is a top view of a reaction chamber of the system of FIG. 3.

### DETAILED DESCRIPTION OF THE INVENTION

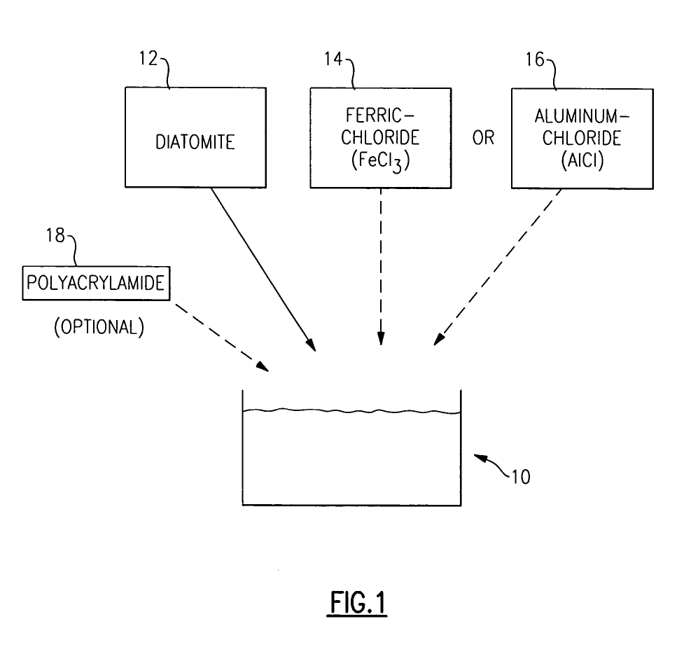

Referring to all of the figures and in particular now to FIG. 1 is shown, a water treatment mixture, identified in general by the reference numeral 10.

A mixture of approximately 50% diatomite 12 by volume that is preferably finely ground or which includes small particles of the diatomite 12 is combined with approximately an equal volume of a metallic chloride mixture, preferably either Ferric Chloride 14 (FeCl₃) or Aluminum Chloride 16. Magnesium Chloride may also be used in certain specialized applications.

It is also preferable to add from 1 to 5 percent polyacrylamide 18, by volume, to the mixture if it is to be used for waste water treatment. Small quantities of polyacrylamide 18 have been shown to accelerate the removal of impurities from the incoming water.

The water treatment mixture 10 is blended to form a homogenous mixture.

Prior to adding the diatomite 12, it is preferably heated, preferably in an iron vessel, to a temperature of from 180 to 200 degrees Fahrenheit. The diatomite 12 is stirred in the iron vessel (i.e., a pan). The heat and stirring combine to produce a durable and mild negative electrical charge to the diatomite 12. When the diatomite 12 is later cooled and used to form the water treatment mixture 10, the diatomite portion thereof tends to retain its negative electrical charge.

If the water treatment mixture 10 is formed by blending the aluminum chloride 16 with the diatomite (whether or not the polyacrylamide 18 is added), the resultant water treatment mixture 10 is a powder that can be stored for one year for later use as a flocculant with little or no loss of efficacy. Tests have shown it to remain stable and effective for use for periods up to about one year.

A sufficient portion of the negative electrical charge is retained for this period of time. No other known prior use of diatomite 12 has resulted in the diatomite 12 receiving a negative charge being applied to the diatomite 12 nor has there been any durability in retaining an electrical charge by the diatomite 12. Accordingly, the method herein described for imparting the electrical charge to the diatomite 12 provides an unexpected benefit of imparting a durable negative electrical charge to the diatomite 12.

If the water treatment mixture 10 is formed by blending the ferric chloride 14 with the diatomite (whether or not the polyacrylamide 18 is added), the resultant water treatment mixture 10 forms a liquid solution that can be stored for an extended period of time for later use as a flocculant. The mixture absorbs ambient moisture (i.e., is hydroscopic) and will eventually become liquid if not shielded from ambient air. If desired, a small additional quantity of water can be added to attain the desired solution (i.e., liquid) in a shorter period of time. A sufficient portion of the negative electrical charge is retained by the mixture (which forms an aqueous solution) for this period of time.

However, over the course of time, the diatomite 12 tends to settle to the bottom of the solution containing the ferric chloride 14. Therefore, the solution can either be used soon after it is initially blended or it can later be re-stirred without detriment prior to use.

The benefits provided by the mixture of diatomite 12 with the metallic chloride 14, 16 result when the two are blended and reacted, as is described later, with the incoming water or waste water. It is also possible, after having had benefit of this disclosure, to add the diatomite 12 and the metallic chloride (any type) separately to the water that is to be treated, as opposed to pre-mixing them and then adding them simultaneously. While it is preferred to premix them, nevertheless it is the combination that is optimally effective at purifying the water.

Accordingly, the instant disclosure describes in detail the preferred products and method for use. However, it is anticipated that a substantial benefit will still be realized providing both the diatomite 12 and the metallic chloride 14, 16 are added to the water that is being treated at some point within the overall time that is allotted for the duration of treatment of the water or waste water. It matters little which is added first providing both are added (i.e., used) during the treatment process and prior to discharge of the treated water.

The use of the water treatment mixture 10 as part of the system herein disclosed is described in greater detail hereinafter, in particular where it is used and how it is reacted with the incoming water or waste water. At this time some of the general benefits that are provided by the water treatment mixture 10 are discussed.

The charged diatomite 12 particles attract and retain small particles, even germs and bacteria, for example, even e coli and other organisms and micro-organisms are removed. The aluminum chloride 16, ferric chloride 14, or other metallic chloride also assumes a small negative electrical charge from the diatomite 12 and is useful in attracting and retaining larger particulates.

The combination is effective at removing a very broad spectrum of pollutants, germs, bacteria, organisms, and various particulates from either industrial waste water or sewage water. The polyacrylamide provides enhanced benefits useful in removing the broad spectrum of pollutants by helping the pollutants adhere better to either the diatomite 12 or to the metallic chloride 14, 16.

Once the water treatment mixture 10 has been reacted (i.e., allowed to commingle with the waste water for a sufficient period of time) the diatomite 12 and the aluminum chloride 16 or the ferric chloride 14 become heavy and tend to settle out and precipitate to the bottom as soon as the flow rates decrease. This forms a sludge that can later be flushed out for use in a landfill or for use as fertilizer.

The cleaned and purified treated water accumulates at the top above the sludge and is directed away from the treatment facility for discharge into a body of water, for example, a lake or river or ocean, or it is recycled for possible further filtering and reuse, for example for crop irrigation or for human consumption as drinking water.

The water treatment mixture 10 has been shown effective at removing heavy metals, inks, and other substances from the waste water. If the waste water includes either a low or a high pH, it is desirable to neutralize the pH, prior to reacting the waste water with the water treatment mixture 10. One reason for first neutralizing the pH is that whatever substance is used to neutralize the pH and whatever substance may remain thereafter, can in all likelihood also be removed from the waste water (or other source of water) by the water treatment mixture 10, thereby resulting in optimum treatment of the water.

At times, the waste water may contain a toxic substance or other substance that requires an additional or special treatment of some kind. This can occur if the waste water is derived from industrial waste water that typically or on occasion contains the toxic of other substance. Specialized treatment is sometimes required for sewage waste water, if for example, an inappropriate dumping in a drain of the toxic or other substances were to occur. Special treatment may also be required if the resultant water can possibly be used as a source of irrigation or drinking water.

In all of these instances it is desirable to perform the additional or special treatment adding whatever material(s) is/are necessary to the waste water to treat the toxic or other substances that may be present before reacting the waste water with the mixture 10. This again is so that whatever substance(s) may remain after the additional or special treatment has occurred, they can in all likelihood also be removed from the waste water by reacting the treated water with the mixture 10.

Similarly, if desired, any bactericide, germicide, or other substances intended to kill or weaken any organisms (bacteria, germs, viruses, micro-organisms, etc.) can also in all likelihood be removed along with dead or weakened organism by the water treatment mixture 10, thereby resulting in optimum treatment of the water. Therefore, these agents (i.e., the bactericide, germicide, etc.) are preferably added to the water prior to reacting the water with the mixture 10.

If the waste (or other source of) water were to include oils that are lighter than water, it is possible for the water treatment mixture 10, after it has been reacted with the waste water, to float to the top rather than precipitate to the bottom of the tank. This is more common with industrial waste waters that include oil based paints and other types of oil based wastes than with sewage systems or drinking water purification systems. If this happens, it is then necessary to sweep the top of the tank to gather and remove the reacted water treatment mixture 10 from the cleaned water which would now be disposed underneath.

It is also possible to vary the proportions of diatomite 12 and the metallic chloride 14, 16 depending upon what pollutants and contaminants are in the waste water. A nearly fifty-fifty mixture by volume is preferred for the ratio of the diatomite 12 to the metallic chloride 14, 16 to start with the polyacrylamide 18 not generally exceeding five percent of the overall total volume. This proportion is varied depending upon the specific needs of the treatment facility. Testing and variation will provide optimum results.

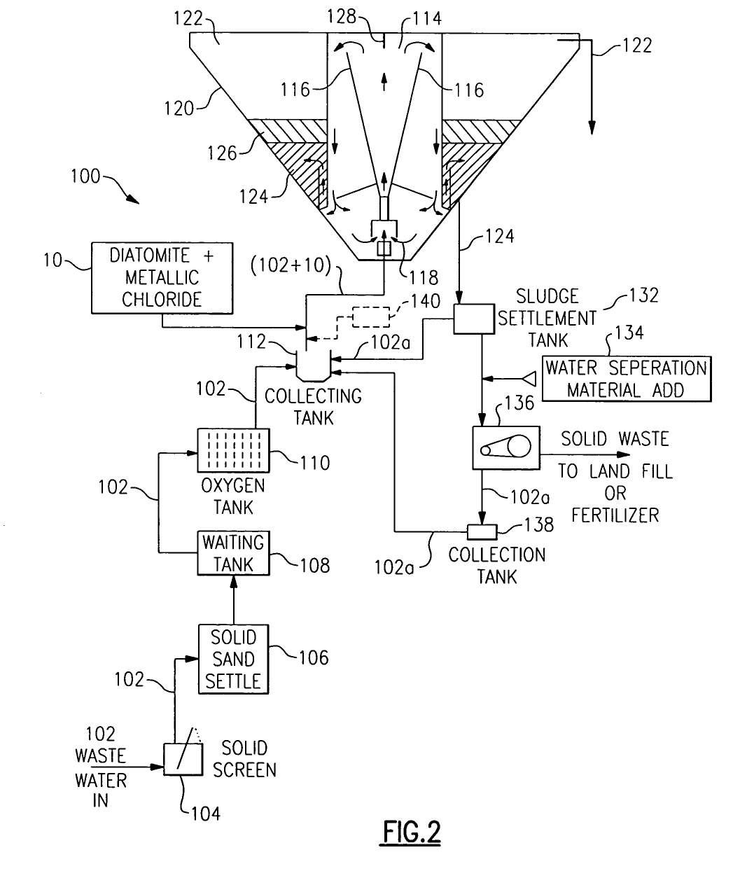

Referring now also to FIGS. 2, 3, and 4, is shown a waste water treatment system, identified in general by the reference numeral 100, that is designed to optimally function with the water treatment mixture 10.

Entering untreated water, herein referred to as “waste water 102” passes through a solid screen station 104 and then to a solid sand settling tank 106 to remove the remaining solids from the waste water 102. From there the waste water 102 goes to a waiting tank 108 and then to an oxygen tank 110 where oxygen (or ambient air) is added to the waste water 102. From there the waste water 102 is directed to a collecting tank 112.

From here, prior to the waste water 102 being pumped into a reaction chamber 114, the water treatment mixture 10 is added in a proportioned mixture and quantity suitable to the degree of pollution in the waste water 102, as was described hereinabove.

The water treatment mixture 10 and waste water 102 enter the reaction chamber 114. Referring now also to FIG. 3, which shows a side view of the reaction chamber 114 (and settling tank 120) of FIG. 2, the reaction chamber 114 includes two pairs of opposite V shaped panels that form a V-shaped funnel 116 that converges close together near the bottom and is wider apart near the top.

The waste water 102 and the water treatment mixture 10 is pumped into the bottom of each reaction chamber 114 inside of the V shaped funnel 116 proximate the convergence point. This forces the waste water 102 and the water treatment mixture 10 up through the V shaped funnel 116 where the water treatment mixture 10 reacts with the waste water 102, attracting (in part, by the negative charge) and adhering the pollutants thereto, as has been previously described.

Overflow of the waste water 102 and the water treatment mixture 10 passes around the tops of the V shaped funnel 116 where it continues to react and flow downward toward the bottom of the V shaped funnel 116. A small opening 118 at the inlet to the V shaped funnel 116 allows the re-circulating and partially reacted mixture to again enter the stream of the waste water 102 and the water treatment mixture 10 that is being forced into the reaction chamber 114. The path taken by the waste water 102 is described in greater detail hereinafter.

This process is repeated for as long as necessary or desired until the diatomite 12 and metallic chloride 14, 16 (whichever is used) that have sufficiently reacted with the waste water 102 become heavier and settle out the bottom through an opening and into a settling tank 120. A clear purified treated water 122 rises to the top for discharge while a sludge 124 forms at the bottom of the settling tank 120. A layer of a mixture of sludge and water 126 forms in-between the sludge 124 and the treated water 122.

The system 100 is designed so that at least one-half of the incoming waste water 102 is re-circulated in the reaction chamber 114. Again, depending upon the specific needs, the amount of re-circulation can be extended as desired.

Ideally, the time for reacting the water treatment mixture 10 with the waste water 102 in the reaction chamber 114 and the time spent in the settling tank 120 until the clear water 122 is of sufficient quality for discharge is not over two hours time. This is considerably faster than any currently known method.

However, this time is a variable that is affected by the design parameters of the system 100, the incoming flow rate of the waste water 102, and the quantity and ratio (i.e., proportions) of the mixture 10 that are applied to the waste water 102. If space is not a problem, it may be more economical in certain instances to increase the size of the settling tank 120 (or tanks) while using a more diluted form of the mixture 10 and allowing considerably more than two hours for treatment to occur.

If the incoming flow rate of the waste water 102 were to increase, then more of the reaction chambers 114 and possibly more settling tanks 120 could be utilized or possibly more of the mixture 10 could be used to accelerate the process, as desired. Therefore, it is to be understood that even though faster treatment times are one benefit provided by the mixture 10 and system 100, a longer treatment time is still possible with many of the benefits herein described being attained at low cost.

whatever substance may remain thereafter, can in all likelihood also be removed from the waste water (or other source of water) by the water treatment mixture 10, thereby resulting in optimum treatment of the water.

A baffle plate 128 is disposed adjacent to each reaction chamber 114. The baffle plates 128 (sees FIGS. 3 & 4) are higher than the V shaped funnels 116 and they are also higher than a water line (117 FIG. 3). Therefore, the baffle plates 128 direct the waste water 102 that enters into each of the reaction chambers 114 into one of two exit paths, a first path 119a and a second path 119b (FIG. 3). The purpose of this is described in greater detail hereinafter.

It is noted that the system 100 and mixture 10 are effective at removing solids from the water 102, but not gases that may be in suspension in the water 102, for example, ammonia, nitrogen, or other odorous gases. Ambient air is forced into the bottom of the oxygen tank 110. Ambient air bubbles form and then rise. As they rise, they capture the bulk of gases that are in suspension taking them to the surface and out of the water.

The location of the oxygen tank 110 can be varied in the system 100 as desired. For example, instead of it being before the collecting tank 112, it could be located later so that it receives the purified treated water 122 that is being discharged from the settlement tank 120 for subsequent removal of the gases from the treated water 122.

It is also noted that, as described hereinabove, it is possible to separately add the diatomite 12 and the metallic chloride 14, 16, either one being added first to the waste water 102, and also to separately add the polyacrylamide 18, providing that the diatomite 12 and the desired metallic chloride 14, 16 are both added before the treated water 122 is discharged from the system 100 (i.e., from the treatment facility).

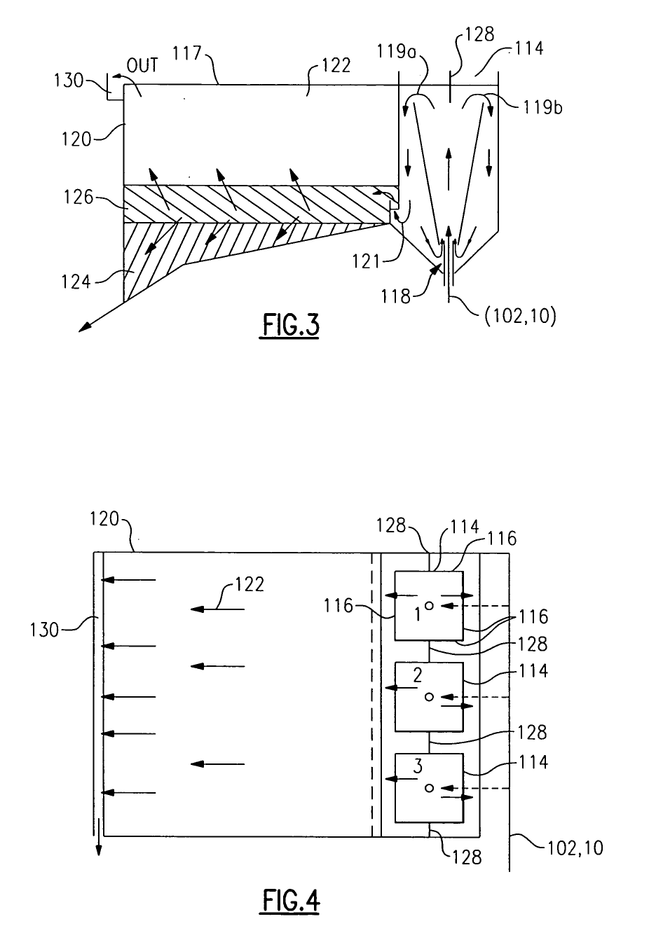

Referring again in particular to FIG. 4, which shows a top view of the reaction chamber 114 and settling tank 120 of FIG. 3, three of the reaction chambers 114 are shown. As incoming volume of the waste water 102 varies, valves (not shown) are opened or closed to direct the incoming waste water 102 that is combined with the water treatment mixture 10 into as many of the reaction chambers 114 as are needed to handle the flow rate. Three reaction chambers 114 per settling tank 120 are generally preferred, however, any number of the reaction chambers 114 can be used with one or more (i.e., any number) of the settling tanks 120 to accommodate any volume of flow for the incoming waste water 102. Accordingly, the mixture 10 and system 100 are scaled up or down in size to accommodate any water treatment or purification need.

The sludge 124 is periodically pumped out for depositing at a land fill or for use as fertilizer. The sludge 124 has retail value and can be sold as fertilizer. The mixture 126 continues to separate forming more sludge 124 that settles to the bottom of the tank 120 and more purified water 122 that rises upward.

It is also noted that flocculation process continues as long as any of the mixture 10 remains in the settling tank 120. Even the sludge 124 at the bottom of the tank 120 continues to attract, by way of its electrical charge, ever more substances until the water 122 is finally discharged out of the tank 120 and system 100.

A channel 130 is provided to direct the clear water 122 out of the settling tank 120 for either direct discharge into a lake, stream, body or water, ocean, or for a possible second treatment, for example, for additional purification for use as a drinking water, or for current reuse as irrigation water, etc., as desired.

The baffle plates 128 are used to direct the waste water 102 rising out of the reaction chambers 114 into either the first path 119a or the second path 119b, as mentioned hereinbefore. The first path 119a circulates to the left (as shown in FIG. 3) where the waste water 102 is directed generally downward toward the small opening 118 at the inlet to the V shaped funnel 116.

Some of the waste water 102 enters into the small opening 118 where it once again flows into the reaction chamber 114 for additional agitation and reacting with the mixture 10. However, a portion of the waste water 102 that travels along the first path 119a is directed away from the small opening 118 and toward the settling tank 120 where it enters the settling tank 120 by passing through a tank inlet 121.

The portion of the waste water 102 entering the settling tank 120 then mingles with the mixture of sludge and water 126 where the reaction with the mixture 10 continues over time, forming additional particulates that precipitate to form more sludge 124 on the bottom while leaving behind more treated water 122 that rises to the top.

Accordingly, it is important to pump out the accumulating sludge 124 so that its level does not rise up to that of the tank inlet 121. This would make it more difficult for any waste water 102 to enter into the settling tank 120.

The waste water 102 that flows out of the reaction chamber 114 along the second path 119b (to the right as shown in FIG. 3) has no choice other than to flow downward to the small opening 118 where it once again all flows into the reaction chamber 114 for additional agitation and reacting with the mixture 10. Since about one-half of all of the waste water 102 that leaves the reaction chamber 114 travels along the second path 119b, this particular half of the waste water 102 is forced to reenter the reaction chamber 114 for additional reacting with the mixture 10.

The mixture 10 and the waste water 102 that is being pumped from the collecting tank 112 into the base of the reaction chamber 114 creates a venturi that helps to draw in all of the waste water 102 that is traveling along the second path 119b and some of the waste water 102 that is traveling along the first path 119a. This ensures that typically, more than one-half and minimally, at least one-half of the waste water 102 entering into the reaction chamber 114 will be forced around to again reenter the reaction chamber 114. This additional reacting improves the efficiency of the system 100.

Referring again to FIG. 2, the sludge 124 is pumped or directed into a sludge settlement tank 132. A water separation material 134 is added (optional) to assist in the separation process and the resultant combination of the sludge 124 and the separation material 134 is directed to a water separation machine 136.

The water separation machine 136 is used to separate additional waste water 102a in the sludge 124 apart from solid waste material in the sludge 124. The water separation machine 136 uses centrifugal force or pressure to typically separate the additional waste water 102a apart from the solid waste material.

The solid waste material portion of the sludge 124 is discharged from the water separation machine 136 into a truck (typical) and is taken either to a land fill or to a processing facility for possible additional treatment, packaging, and eventual sale for use as fertilizer.

The additional waste water 102a that is extracted from the sludge 124 by the water separation machine 136 is directed to a collection tank 138. From the collection tank 138, the additional waste water 102a is sent again to the collecting tank 112 for additional reacting, as was previously described.

Similar additional waste water 102a is obtained from the sludge settlement tank 132 and is also directed back to the collecting tank 112 for additional reacting.

It is further noted that if an optional material for use as a bactericide/germicide 140 that is intended to kill or weaken any organisms such as bacteria, germs, viruses, micro-organisms, etc. are to be used, the material used as the bactericide/germicide 140 is preferably added before the mixture 10 is added to the waste water 102 so that when the mixture 10 (i.e., the flocculant) is reacted with the waste water 102, the remaining bactericide/germicide 140 and the remaining dead or weakened bacteria, germs, and viruses can be removed as well from the water 102. The same timing applies, as was previously described, to neutralizing the pH, or for any other treatment (i.e., for substances or toxins) that is to be accomplished.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

For example, for certain applications, the metallic chloride 14, 16 that is used to form the mixture 10 may include an assortment of two or more metallic chlorides 14, 16.

What is claimed is:

1.-61. (canceled)

62. A mixture forming a flocculant for use in water treatment comprising a diatomite having a negative electrical charge formed by heating and stirring the diatomite.

63. A mixture forming a flocculant as set forth in claim 62 wherein the heating and stirring of the diatomite takes place in an iron vessel.

64. A mixture forming a flocculant as set forth in claim 63 wherein the diatomite is heated to about 180° F. to 200° F.

65. A mixture forming a flocculant as set forth in claim 62 further comprising a metallic chloride mixture.

66. A mixture forming a flocculant as set forth in claim 65 wherein the diatomite is provided in about 50% by volume of the flocculant mixture.

67. A mixture forming a flocculant as set forth in claim 65 wherein the metallic chloride is provided in about 50% by volume of the flocculant mixture.

68. A mixture forming a flocculant as set forth in claim 65 wherein the metallic chloride is selected from a group consisting of ferric chloride, aluminum chloride, and magnesium chloride.

69. A mixture forming a flocculant as set forth in claim 65 wherein the metallic chloride mixture has a negative electric charge.

70. A mixture forming a flocculent as set forth in claim 65 further comprising a polyacrylamide.

71. A mixture forming a flocculant as set forth in claim 70 wherein the polyacrylamide is provided in about 1%-5% by volume of the flocculant mixture.

72. A mixture forming a flocculant as set forth in claim 62 wherein the flocculant mixture is in powder form.

73. A mixture forming a flocculant as set forth in claim 62 wherein the flocculant mixture is in liquid form.

74. A method of producing a flocculent for removing a substance from water, comprising:
providing a diatomite; and
heating and stirring the diatomite to form a negative electrical charge on the diatomite;

75. A method for producing a flocculant as set forth in claim 74 further comprising combining the negatively electrically charged diatomite with a metallic chloride.

76. A method for producing a flocculant as set forth in claim 74 wherein the heating and stirring of the diatomite is performed in an iron vessel.

77. A method for producing a flocculant as set forth in claim 75 wherein heating and stirring the diatomite in an iron vessel comprises heating the diatomite to about 180° F. to 200° F.
